(19) United States
(12) Patent Application Publication
(10) Pub. No.: US 2019/0108007 A1
(43) Pub. Date: Apr. 11, 2019

(54) System and Method of Managing Processor Instructions Associated with a Device

(71) Applicant: Dell Products L.P., Round Rock, TX (US)

(72) Inventors: Swee Chay Hia, Singapore (SG); Shun-tang Hsu, Taipei (TW)

(21) Appl. No.: 15/727,364

(22) Filed: Oct. 6, 2017

(51) Int. Cl. G06F 9/445; H04L 29/08

(52) U.S. Cl. CPC G06F 8/61; H04L 67/34; G06F 9/44505

(57) ABSTRACT

In one or more embodiments, one or more systems, methods, and/or processes may receive a first device identification from a first device of a first information handling system; determine an identification associated with the first information handling system; determine a first identifier based at least on the identification associated with the first information handling system and the first device identification; provide the first identifier, based at least on the identification associated with the first information handling system and the first device identification, and a first version identification of a first firmware associated with the first device of the first information handling system to a second information handling system, different from the first information handling system, via a network; and receive a second firmware, different from the first firmware, via the network. In one or more embodiments, the second firmware may be installed to the first device.

### BACKGROUND

### Field of the Disclosure

This disclosure relates generally to information handling systems and more particularly to distributing and receiving processor instructions.

### Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

### SUMMARY

In one or more embodiments, one or more systems, methods, and/or processes may receive a first device identification from a first device of a first information handling system. For example, the first information handling system may include the first device. For instance, the first device identification may be associated with one or more of a manufacturer of the first device, a model of the first device, a type of the first device, subsystem information of the first device, revision information of the first device, and subsystem manufacturer information of the first device. In one or more embodiments, an identification associated with the first information handling system may be determined. For example, the identification associated with the first information handling system may include an identification associated with a manufacturer of the first information handling system. In one or more embodiments, a first identifier based at least on the identification associated with the first information handling system and the first device identification may be determined. For example, the identifier based at least on the identification associated with the first information handling system and the first device identification may include one or more of a globally unique identifier (GUID), an universally unique identifier (UUID), and a hash value, among others. In one or more embodiments, the first identifier, based at least on the identification associated with the first information handling system and the first device identification, and a first version identification of a first firmware associated with the first device of the first information handling system may be provided to a second information handling system, different from the first information handling system, via a network. In one or more embodiments, a second firmware, different from the first firmware, may be received via the network. In one example, the second firmware may be received from a system associated with the second information handling system. In a second example, the second firmware may be received from the second information handling system. In another example, the first information handling system may receive the second firmware. In one or more embodiments, the second firmware, that is different from the first firmware, may be selected for the first information handling system based at least on the first identifier and the first version identification of the first firmware. For example, the second firmware may include instructions, which are executable by a processor of the first device to implement one or more functionalities of the first device.

### BRIEF DESCRIPTION OF THE DRAWINGS

For a more complete understanding of the present disclosure and its features/advantages, reference is now made to the following description, taken in conjunction with the accompanying drawings, which are not drawn to scale, and in which:

FIG. 1 illustrates an example of an information handling system, according to one or more embodiments;

FIG. 2 illustrates an example computing environment, according to one or more embodiments;

FIG. 3 illustrates an example of a method of updating processor instructions, according to one or more embodiments;

FIG. 4 illustrates an example of a method of building an identifier entry, according to one or more embodiments;

FIG. 5 illustrates an example of entries that include unique identifications; and

FIG. 6 illustrates an example of a method of operating an information handling system, according to one or more embodiments.

### DETAILED DESCRIPTION

In the following description, details are set forth by way of example to facilitate discussion of the disclosed subject matter. It should be apparent to a person of ordinary skill in the field, however, that the disclosed embodiments are exemplary and not exhaustive of all possible embodiments.

As used herein, a reference numeral followed by a letter refers to a specific instance of an element and the numeral only form of the reference numeral refers to the collective element. Thus, for example, device ‘12A’ refers to an instance of a device class, which may be referred to collectively as devices ‘12’ and any one of which may be referred to generically as a device ‘12’.

In one or more embodiments, a first information handling system may receive a first device identification from a first device associated with the information handling system. For example, the first information handling system may include the first device. For instance, the first device identification may be associated with one or more of a manufacturer of the first device, a model of the first device, a type of the first device, subsystem information of the first device, revision information of the first device, and subsystem manufacturer information of the first device. In one or more embodiments, an identification associated with the first information handling system may be determined. For example, the identification associated with the first information handling system may include an identification associated with a manufacturer of the first information handling system. For instance, the identification associated with the manufacturer of the first information handling system may include one or more letters and/or one or more numbers, among other characters.

In one or more embodiments, a first identifier based at least on the identification associated with the first information handling system and the first device identification may be determined. In one example, the identifier based at least on the identification associated with the first information handling system and the first device identification may include one or more of a globally unique identifier (GUID) and an universally unique identifier (UUID). In another example, the identifier based at least on the identification associated with the first information handling system and the first device identification may include a hash value. For instance, the identification associated with the first information handling system and the first device identification may be utilized in generating the hash value.

In one or more embodiments, the first identifier, based at least on the identification associated with the first information handling system, and a first version identification of a first firmware associated with the first device may be provided to a second information handling system. For example, the first identifier, based at least on the identification associated with the first information handling system and the first device identification, and the first version identification of the first firmware associated with the first device may be provided to the second information handling system via a network.

In one or more embodiments, a second firmware, different from the first firmware, may be received. For example, the second firmware may be received via a network. For instance, the first information handling system may receive the second firmware, which may be received via a network. In one or more embodiments, the second firmware may be installed to the first device. For example, the first information handling system may install the second firmware to the first device. For instance, at least one of the an operating system of the first information handling system, an information handling system firmware of the first information handling system, and an application of the first information handling system may install the second firmware to the first device.

In one or more embodiments, the first information handling system may receive the first device identification from a second device associated with the first information handling system, different from the first device associated with the first information handling system. For example, the first device and the second device may be of a same model from a same manufacturer. In one or more embodiments, the first information handling system may receive a second device identification from a second device associated with the information handling system, different from the first device associated with the information handling system. For example, the first device and the second device may be of two different manufacturers and/or may be of two different models, among others. For instance, the second device identification may be different from the first device identification. In one or more embodiments, a second identifier based at least on the identification associated with the first information handling system and the second device identification may be determined. For example, the second identifier, based at least on the identification associated with the first information handling system and the second device identification, and a second version identification of a third firmware associated with the second device may be provided to the second information handling system via the network. For instance, a fourth firmware, different from the third firmware, may be received via the network.

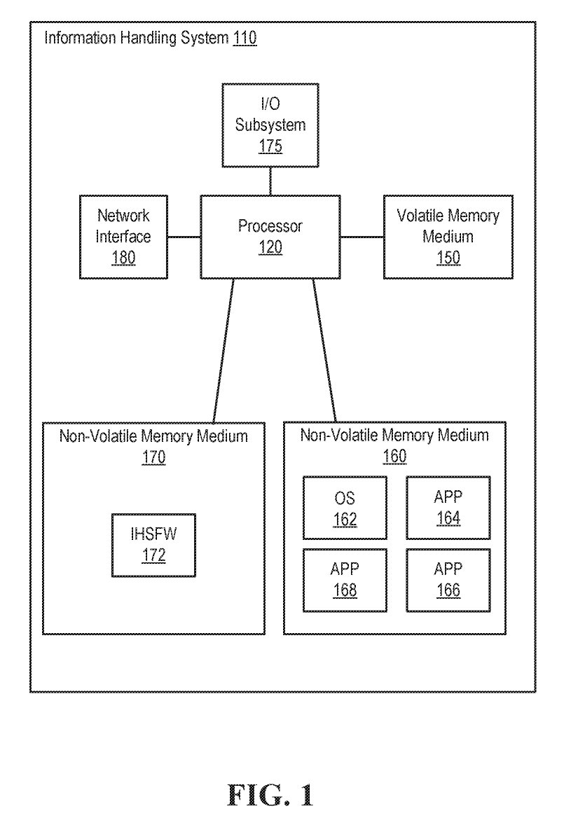

Turning now to FIG. 1, an exemplary information handling system is illustrated, according to one or more embodiments. An information handling system (IHS) 110 may include a hardware resource or an aggregate of hardware resources operable to compute, classify, process, transmit, receive, retrieve, originate, switch, store, display, manifest, detect, record, reproduce, handle, and/or utilize various forms of information, intelligence, or data for business, scientific, control, entertainment, or other purposes, according to one or more embodiments. For example, IHS 110 may be a personal computer, a desktop computer system, a laptop computer system, a server computer system, a mobile device, a personal digital assistant (PDA), a consumer electronic device, an electronic music player, an electronic camera, an electronic video player, a network storage device, or another suitable device and may vary in size, shape, performance, functionality, and price. In one or more embodiments, components of IHS 110 may include one or more storage devices, one or more communications ports for communicating with external devices as well as various input and output (I/O) devices, such as a keyboard, a mouse, and a video display, among others. In one or more embodiments, IHS 110 may include one or more buses operable to transmit communication between or among two or more hardware components. In one example, a bus of IHS 110 may include one or more of a memory bus, a peripheral bus, and a local bus, among others. In another example, a bus of IHS 110 may include one or more of a Micro Channel Architecture (MCA) bus, an Industry Standard Architecture (ISA) bus, an Enhanced ISA (EISA) bus, a Peripheral Component Interconnect (PCI) bus, HyperTransport (HT) bus, an inter-integrated circuit (I²C) bus, a serial peripheral interface (SPI) bus, a low pin count (LPC) bus, an enhanced serial peripheral interface (eSPI) bus, a universal serial bus (USB), a system management bus (SMBus), and a Video Electronics Standards Association (VESA) local bus, among others.

In one or more embodiments, IHS 110 may include firmware that controls and/or communicates with one or more hard drives, network circuitry, one or more memory devices, one or more I/O devices, and/or one or more other peripheral devices. For example, firmware may include software embedded in an IHS component utilized to perform tasks. In one or more embodiments, firmware may be stored in non-volatile memory, such as storage that does not lose stored data upon loss of power. In one example, firmware associated with an IHS component may be stored in non-volatile memory that is accessible to one or more IHS components. In another example, firmware associated with an IHS component may be stored in non-volatile memory that may be dedicated to and includes part of that component. For instance, an embedded controller may include firmware that may be stored via non-volatile memory that may be dedicated to and includes part of the embedded controller.

As shown, IHS 110 may include a processor 120, a volatile memory medium 150, non-volatile memory media 160 and 170, an I/O subsystem 175, and a network interface 180. As illustrated, volatile memory medium 150, non-volatile memory media 160 and 170, I/O subsystem 175, and network interface 180 may be communicatively coupled to processor 120.

In one or more embodiments, one or more of volatile memory medium 150, non-volatile memory media 160 and 170, I/O subsystem 175, and network interface 180 may be communicatively coupled to processor 120 via one or more buses, one or more switches, and/or one or more root complexes, among others. In one example, one or more of volatile memory medium 150, non-volatile memory media 160 and 170, I/O subsystem 175, and network interface 180 may be communicatively coupled to processor 120 via one or more PCI-Express (PCIe) root complexes. In another example, one or more of an I/O subsystem 175 and a network interface 180 may be communicatively coupled to processor 120 via one or more PCIe switches.

In one or more embodiments, the term “memory medium” may mean a “storage device”, a “memory”, a “memory device”, a “tangible computer readable storage medium”, and/or a “computer-readable medium”. For example, computer-readable media may include, without limitation, storage media such as a direct access storage device (e.g., a hard disk drive, a floppy disk, etc.), a sequential access storage device (e.g., a tape disk drive), a compact disk (CD), a CD-ROM, a digital versatile disc (DVD), a random access memory (RAM), a read-only memory (ROM), a one-time programmable (OTP) memory, an electrically erasable programmable read-only memory (EEPROM), and/or a flash memory, a solid state drive (SSD), or any combination of the foregoing, among others.

In one or more embodiments, one or more protocols may be utilized in transferring data to and/or from a memory medium. For example, the one or more protocols may include one or more of small computer system interface (SCSI), Serial Attached SCSI (SAS) or another transport that operates with the SCSI protocol, advanced technology attachment (ATA), serial ATA (SATA), a USB interface, an Institute of Electrical and Electronics Engineers (IEEE) 1394 interface, a Thunderbolt interface, an advanced technology attachment packet interface (ATAPI), serial storage architecture (SSA), integrated drive electronics (IDE), or any combination thereof, among others.

Volatile memory medium 150 may include volatile storage such as, for example, RAM, DRAM (dynamic RAM), EDO RAM (extended data out RAM), SRAM (static RAM), etc. One or more of non-volatile memory media 160 and 170 may include nonvolatile storage such as, for example, a read only memory (ROM), a programmable ROM (PROM), an erasable PROM (EPROM), an electrically erasable PROM, NVRAM (non-volatile RAM), ferroelectric RAM (FRAM), a magnetic medium (e.g., a hard drive, a floppy disk, a magnetic tape, etc.), optical storage (e.g., a CD, a DVD, a BLU-RAY disc, etc.), flash memory, a SSD, etc. In one or more embodiments, a memory medium can include one or more volatile storages and/or one or more nonvolatile storages.

In one or more embodiments, network interface 180 may be utilized in communicating with one or more networks and/or one or more other information handling systems. In one example, network interface 180 may enable IHS 110 to communicate via a network utilizing a suitable transmission protocol and/or standard. In a second example, network interface 180 may be coupled to a wired network. In a third example, network interface 180 may be coupled to an optical network. In another example, network interface 180 may be coupled to a wireless network.

In one or more embodiments, network interface 180 may be communicatively coupled via a network to a network storage resource. For example, the network may be implemented as, or may be a part of, a storage area network (SAN), personal area network (PAN), local area network (LAN), a metropolitan area network (MAN), a wide area network (WAN), a wireless local area network (WLAN), a virtual private network (VPN), an intranet, an Internet or another appropriate architecture or system that facilitates the communication of signals, data and/or messages (generally referred to as data). For instance, the network may transmit data utilizing a desired storage and/or communication protocol, including one or more of Fibre Channel, Frame Relay, Asynchronous Transfer Mode (ATM), Internet protocol (IP), other packet-based protocol, Internet SCSI (iSCSI), or any combination thereof, among others.

In one or more embodiments, processor 120 may execute processor instructions in implementing one or more systems, flowcharts, methods, and/or processes described herein. In one example, processor 120 may execute processor instructions from one or more of memory media 150-170 in implementing one or more systems, flowcharts, methods, and/or processes described herein. In another example, processor 120 may execute processor instructions via network interface 180 in implementing one or more systems, flowcharts, methods, and/or processes described herein.

In one or more embodiments, processor 120 may include one or more of a system, a device, and an apparatus operable to interpret and/or execute program instructions and/or process data, among others, and may include one or more of a microprocessor, a microcontroller, a digital signal processor (DSP), an application specific integrated circuit (ASIC), and another digital or analog circuitry configured to interpret and/or execute program instructions and/or process data, among others. In one example, processor 120 may interpret and/or execute program instructions and/or process data stored locally (e.g., via memory media 150-170 and/or another component of IHS 110). In another example, processor 120 may interpret and/or execute program instructions and/or process data stored remotely (e.g., via a network storage resource).

In one or more embodiments, I/O subsystem 175 may represent a variety of communication interfaces, graphics interfaces, video interfaces, user input interfaces, and/or peripheral interfaces, among others. For example, I/O subsystem 175 may include one or more of a touch panel and a display adapter, among others. For instance, a touch panel may include circuitry that enables touch functionality in conjunction with a display that is driven by a display adapter.

As shown, non-volatile memory medium 160 may include an operating system (OS) 162, and applications (APPs) 164-168. In one or more embodiments, one or more of OS 162 and APPs 164-168 may include processor instructions executable by processor 120. In one example, processor 120 may execute processor instructions of one or more of OS 162 and APPs 164-168 via non-volatile memory medium 160. In another example, one or more portions of the processor instructions of the one or more of OS 162 and APPs 164-168 may be transferred to volatile memory medium 150, and processor 120 may execute the one or more portions of the processor instructions of the one or more of OS 162 and APPs 164-168 via volatile memory medium 150.

As illustrated, non-volatile memory medium 170 may include information handling system firmware (IHSFW) 172. In one or more embodiments, IHSFW 172 may include processor instructions executable by processor 120. For example, IHSFW 172 may include one or more structures and/or functionalities of one or more of a basic input/output system (BIOS), an Extensible Firmware Interface (EFI), a Unified Extensible Firmware Interface (UEFI), and an Advanced Configuration and Power Interface (ACPI), among others. In one instance, processor 120 may execute processor instructions of IHSFW 172 via non-volatile memory medium 170. In another instance, one or more portions of the processor instructions of IHSFW 172 may be transferred to volatile memory medium 150, and processor 120 may execute the one or more portions of the processor instructions of IHSFW 172 via volatile memory medium 150.

In one or more embodiments, processor 120 and one or more components of IHS 110 may be included in a system-on-chip (SoC). For example, the SoC may include processor 120 and a platform controller hub (not specifically illustrated).

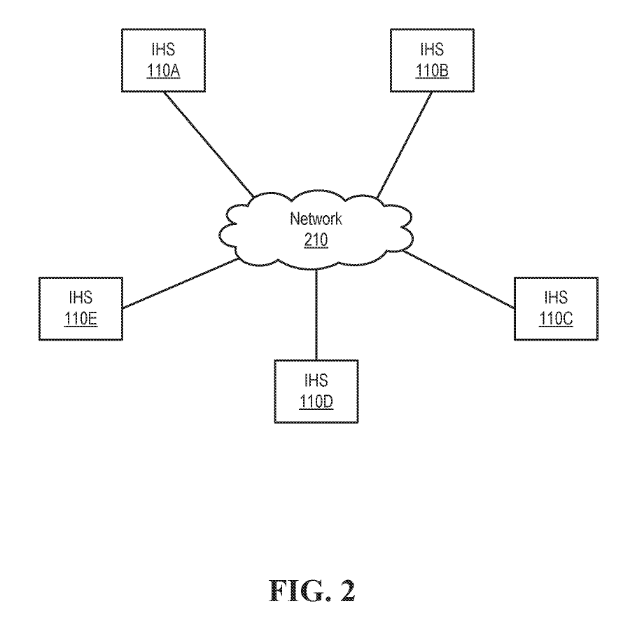

Turning now to FIG. 2, an example computing environment is illustrated, according to one or more embodiments. As shown, information handling systems (IHSs) 110A-110E may be coupled to a network 210. In one or more embodiments, network 210 may include a wired network, a wireless network, an optical network, or a combination of the foregoing, among others. For example, network 210 may include and/or be coupled to various types of communications networks. For instance, network 210 may include and/or be coupled to a LAN, a WAN (e.g., a private WAN, a corporate WAN, a public WAN, etc.), an Internet, a public switched telephone network (PSTN), a cellular telephone network, a satellite telephone network, or a combination of the foregoing, among others.

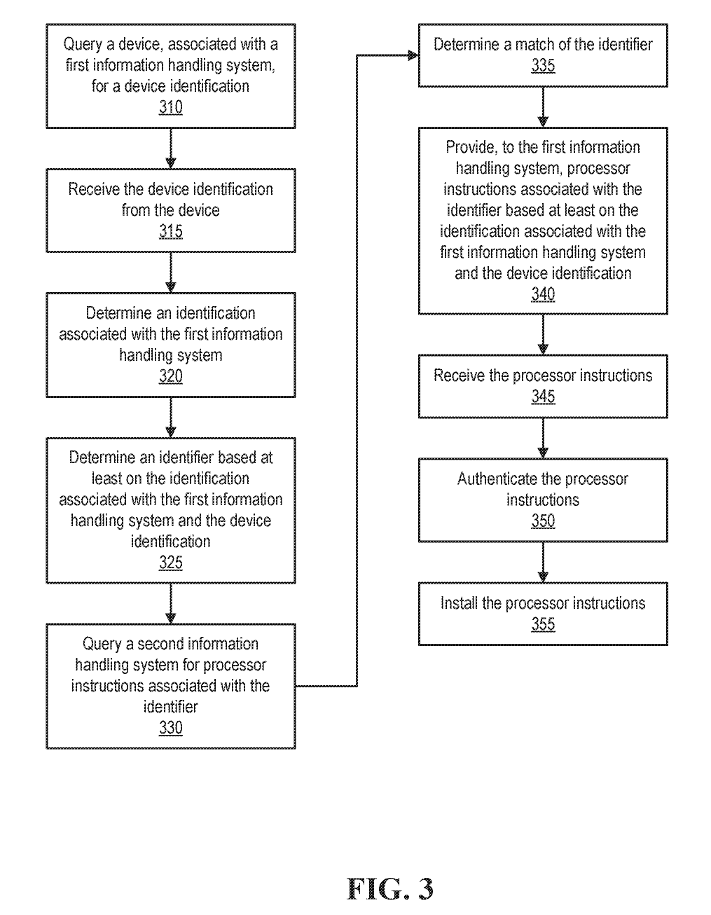

Turning now to FIG. 3, an example of a method of updating processor instructions is illustrated, according to one or more embodiments. At 310, a device, associated with a first information handling system, may be queried for a device identification. For example, the first information handling system may query the device for the device identification. For instance, one or more of OS 162, APP 164, and IHSFW 172 may query the device for the device identification. In one or more embodiments, the first information handling system may include the device. At 315, the device identification may be received from the device. For example, the first information handling system may receive the device identification. For instance, one or more of OS 162, APP 164, and IHSFW 172 may receive the device identification. In one or more embodiments, the device identification may include one or more letters and/or one or more numbers, among other characters (e.g., one or more dashes, one or more periods, one or more parenthesis, one or more white spaces, Unicode characters, etc.).

At 320, an identification associated with the first information handling system may be determined. For example, the first information handling system may determine the identification associated with the first information handling system. For instance, one or more of OS 162, APP 164, and IHSFW 172 may determine the identification associated with the first information handling system. In one or more embodiments, the identification associated with the first information handling system may include one or more letters and/or one or more numbers, among other characters (e.g., one or more dashes, one or more periods, one or more parenthesis, one or more white spaces, Unicode characters, etc.). In one example, the identification associated with the first information handling system may include “DELL”. In a second example, the identification associated with the first information handling system may include 0xDE11. In another example, the identification associated with the first information handling system may include “Dell Latitude e7470”.

At 325, an identifier based at least on the identification associated with the first information handling system and the device identification may be determined. For example, the first information handling system may determine the identifier based at least on the identification associated with the first information handling system and the device identification. For instance, one or more of OS 162, APP 164, and IHSFW 172 may determine the identifier based at least on the identification associated with the first information handling system and the device identification. In one or more embodiments, a unique identifier based at least on the identification associated with the first information handling system and the device identification may be determined. In one example, one or more of a GUID and an UUID based at least on the identification associated with the first information handling system and the device identification may be determined. In one instance, the identifier may be the GUID. In a second instance, the identifier may be the UUID. In another instance, the identifier may include one or more of the GUID and the UUID. In another example, a hash value based at least on the identification associated with the first information handling system and the device identification may be determined. For instance, the identifier may be or include the hash value. In one or more embodiments, a method and/or process that includes a low probability of generating collisions may be utilized in determining an identifier based at least on the identification associated with the first information handling system and the device identification may be determined. For example, utilizing the method and/or process that includes a low probability of generating collisions may be considered to produce “unique” output values, since it includes the low probability of generating collisions. For instance, the identifier may be or include output from the method and/or process that includes the low probability of generating collisions.

At 330, a second information handling system may be queried for processor instructions associated with the identifier. For example, a query that includes the identifier, based at least on the identification associated with the first information handling system and the device identification, may be provided to the second information handling system. For instance, the query may include version information of processor instructions that are include in the first information handling system. In one or more embodiments, the second information handling system may be queried for the processor instructions via a network. For example, the network may include network 210.

At 335, a match of the identifier may be determined. In one or more embodiments, determining the match of the identifier may include determining processor instructions that are associated with the identifier and/or that correspond to the identifier. In one example, the second information handling system may determine the match. In another example, a system associated with the second information handling system may determine the match. For instance, another information handling system, (e.g., a database system) associated with the second information handling system, may determine the match. At 340, the processor instructions may be provided to the first information handling system. In one example, the second information handling system may provide the processor instructions to the first information handling system. In another example, a system associated with the second information handling system may provide the processor instructions to the first information handling system. In one or more embodiments, the processor instructions may be provided to the first information handling system via a network. For example, the network may include network 210. In one or more embodiments, the processor instructions may include one or more of a device driver, a device driver update, a firmware for the device, and a firmware update for the device, among others.

At 345, the processor instructions may be received. For example, the first information handling system may receive the processor instructions. For instance, one or more of OS 162, APP 164, and IHSFW 172 may receive the processor instructions. In one or more embodiments, the processor instructions may be received via a network. For example, the network may include network 210. At 350, the processor instructions may be authenticated. In one example, the first information handling system may authenticate the processor instructions. For instance, one or more of OS 162, APP 164, and IHSFW 172 may authenticate the processor instructions. In another example, the device may authenticate the processor instructions. At 355, the processor instructions may be installed. For example, the first information handling system may install the processor instructions. For instance, one or more of OS 162, APP 164, and IHSFW 172 may install the processor instructions. In one or more embodiments, installing the processor instructions may include storing the processor instructions via one or more non-volatile memory media. In one example, the one or more non-volatile memory media may include one or more of non-volatile memory media 160 and 170. In another example, the device may include the one or more non-volatile memory media. For instance, the processor instructions may be installed to the device, where a processor of the device may execute the processor instructions.

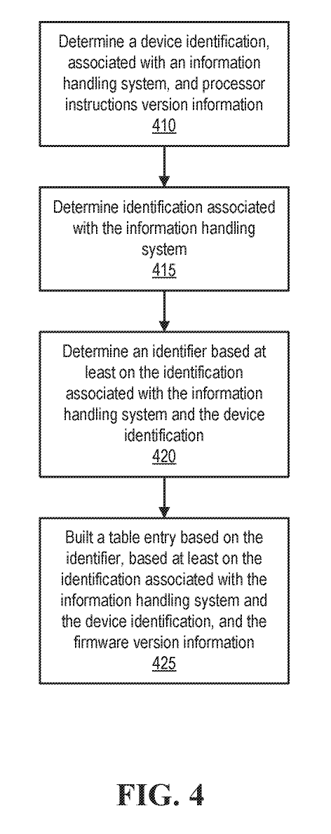

Turning now to FIG. 4, an example of a method of building an identifier entry is illustrated, according to one or more embodiments. At 410, a device identification, associated with an information handling system, and processor instructions version information may be determined. In one example, a device may be queried for the device identification in determining the device identification. For instance, IHSFW 172 may query the device for the device identification in determining the device identification. In another example, one or more of the device and an OS may be queried for the processor instructions version information in determining the processor instructions version information. For instance, IHSFW 172 may query one or more of the device and OS 162 in determining the processor instructions version information. In one or more embodiments, processor instructions associated with the processor instructions version information may include one or more of a device driver and a firmware, among others. For example, the firmware may include processor instructions for the device.

At 415, an identification associated with the information handling system may be determined. For example, IHSFW 172 may determine the identification associated with the information handling system. In one or more embodiments, the identification associated with the information handling system may include one or more letters and/or one or more numbers, among other characters (e.g., one or more dashes, one or more periods, one or more parenthesis, one or more white spaces, Unicode characters, etc.). For example, the identification associated with the information handling system may include manufacturer information. In one instance, the manufacturer information may include “DELL”. In a second instance, the manufacturer information may include 0xDE11. In another instance, the manufacturer information may include “Dell Latitude e7470”.

At 420, an identifier based at least on the identification associated with the information handling system and the device identification may be determined. For example, IHSFW 172 may determine the identifier based at least on the identification associated with the information handling system and the device identification. In one or more embodiments, a unique identifier based at least on the identification associated with the information handling system and the device identification may be determined. In one example, one or more of a GUID and an UUID based at least on the identification associated with the information handling system and the device identification may be determined. In another example, a hash value based at least on the identification associated with the information handling system and the device identification may be determined. In one or more embodiments, a method and/or process that includes a low probability of generating collisions may be utilized in determining an identifier based at least on the identification associated with the first information handling system and the device identification may be determined. For example, utilizing the method and/or process that includes a low probability of generating collisions may be considered to produce “unique” output values, since it includes the low probability of generating collisions.

At 425, a table entry based on the identifier, based at least on the identification associated with the information handling system and the device identification, may be built. In one or more embodiments, building the table entry may include creating and/or inserting the table entry in a table. For example, the table may be or include an array. For instance, the table may be or include a firmware interface system resource table resource entry array.

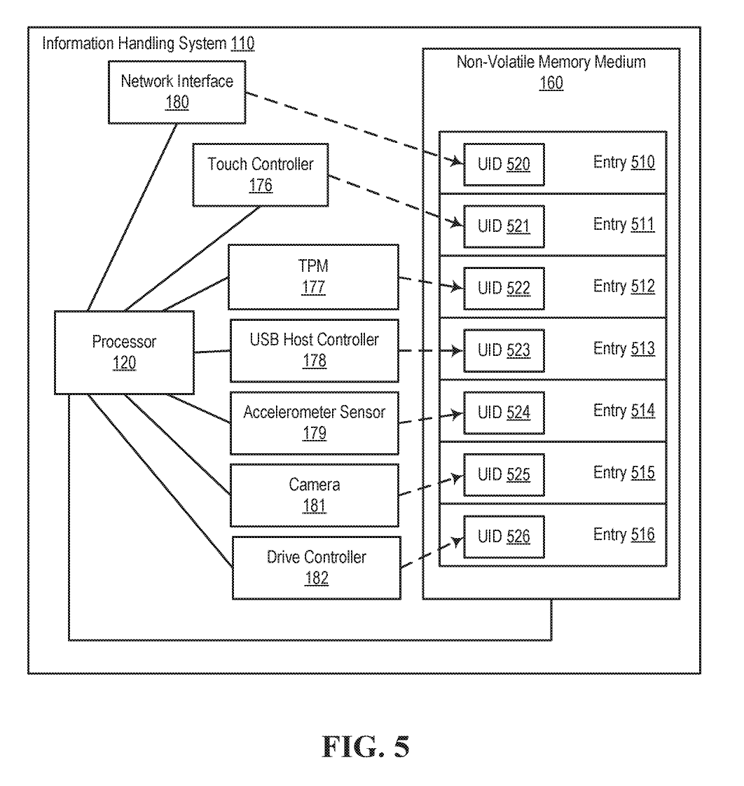

In one or more embodiments, the table entry may include the identifier, based at least on the identification associated with the information handling system and the device identification, and the processor instructions version information, among others. For example, as illustrated in FIG. 5, entries 510-516 may include respective unique identifiers (UIDs) 520-526. In one instance, IHS 110 may also include, among others, a touch controller 176, a trusted platform module (TPM) 177, an USB host controller 178, an accelerometer sensor 179, a camera 181, and a drive controller 182 (e.g., a SATA drive controller, a NVMe driver controller, etc.), which may be coupled to processor 120. In another instance, as shown with dashed arrows, information from network interface 180, touch controller 176, TPM 177, USB host controller 178, accelerometer sensor 179, camera 181, and driver controller 182 may be utilized in creating and/or generating respective UIDs 520-526.

In one or more embodiments, non-volatile memory medium 160 may store entries 510-516, among others. For example, a firmware resource entry array may include entries 510-516, among others. In one instance, an unified extensible firmware interface system resource table resource entry array may include entries 510-516, among others. In another instance, an extensible firmware interface system resource table resource entry array may include entries 510-516, among others.

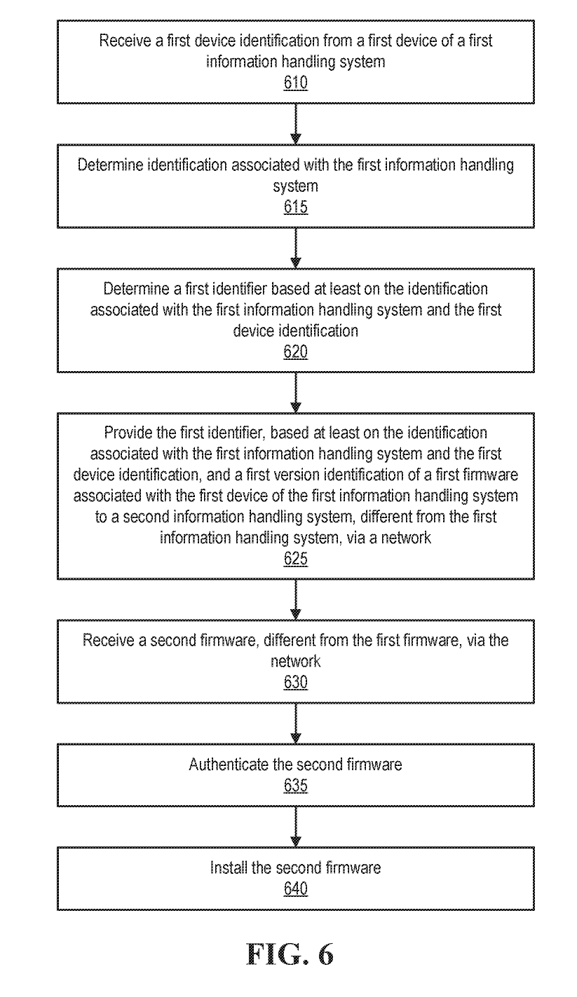

Turning now to FIG. 6, an example of a method of operating an information handling system is illustrated, according to one or more embodiments. At 610, a first device identification from a first device of a first information handling system may be received. For example, the first information handling system may include the first device. For instance, the first device identification may be associated with one or more of a manufacturer of the first device, a model of the first device, a type of the first device, subsystem information of the first device, revision information of the first device, and subsystem manufacturer information of the first device, among others. In one or more embodiments, the first device identification may one or more letter and/or one or more numbers, among other characters (e.g., one or more dashes, one or more periods, one or more parenthesis, one or more white spaces, Unicode characters, etc.). At 615, an identification associated with the first information handling system may be determined. For example, the identification associated with the first information handling system may include an identification of a manufacturer of the first information handling system. For instance, the identification of the manufacturer of the first information handling system may include one or more letters and/or one or more numbers, among other characters (e.g., one or more dashes, one or more periods, one or more parenthesis, one or more white spaces, Unicode characters, etc.).

At 620, a first identifier based at least on the identification associated with the first information handling system and the first device identification may be determined. In one example, the identifier based at least on the identification associated with the first information handling system and the first device identification may include one or more of a GUID and an UUID, among others. In another example, the identifier based at least on the identification associated with the first information handling system and the first device identification may include a hash value. For instance, the identification associated with the first information handling system and the first device identification may be utilized in generating the hash value. In one or more embodiments, a method and/or process that includes a low probability of generating collisions may be utilized in determining an identifier based at least on the identification associated with the first information handling system and the device identification may be determined. For example, utilizing the method and/or process that includes a low probability of generating collisions may be considered to produce “unique” output values, since it includes the low probability of generating collisions.

At 625, the first identifier, based at least on the identification associated with the first information handling system and the first device identification, and a first version identification of a first firmware associated with the first device of the first information handling system may be provided, via a network, to a second information handling system, different from the first information handling system. For example, the first information handling system may be information handling system 110A and the second information handling system may be information handling system 110C. For instance, the network may be network 210.

In one or more embodiments, the first device may utilize the first firmware in implementing one or more structures and/or functionalities of the first device. In one example, the first firmware may include first configuration information. For instance, the first configuration information may be utilized in implementing one or more structures of the first device (e.g., configuring a field programmable gate array (FPGA)). In another example, the first firmware may include first processor instructions. For instance, the first processor instructions may be utilized in implementing one or more functionalities of the first device. In one or more embodiments, the first processor instructions may be executable by a processor and/or a FPGA of the first device. For example, the processor and/or the FPGA of the first device may execute the first processor instructions in implementing one or more functionalities of the first device.

At 630, a second firmware, different from the first firmware, may be received via the network. In one example, the second firmware may be received from a system associated with the second information handling system. In another example, the second firmware may be received from the second information handling system.

In one or more embodiments, the first device may utilize the second firmware in implementing one or more structures and/or functionalities of the first device. In one example, the second firmware may include second configuration information. For instance, the second configuration information may be utilized in implementing one or more structures of the first device (e.g., configuring a FPGA). In another example, the second firmware may include second processor instructions. For instance, the second processor instructions may be utilized in implementing one or more functionalities of the first device. In one or more embodiments, the second processor instructions may be executable by a processor and/or a FPGA of the first device. For example, the processor and/or the FPGA of the first device may execute the second processor instructions in implementing one or more functionalities of the first device.

At 635, the second firmware may be authenticated. In one example, the first information handling system may authenticate the second firmware. For instance, one or more of OS 162, APPs 164-168, and IHSFW 172 may authenticate the second firmware. In another example, the first device may authenticate the second firmware. At 640, the second firmware may be installed. For example, one or more of OS 162, APPs 164-168, and IHSFW 172 may install the second firmware. In one instance, installation of the second firmware may be automatic. In a second instance, installation of the second firmware may be performed in response to user input that may indicate that the second firmware is to be installed. In another instance, installing the second firmware may include installing the second firmware to the first device. In one or more embodiments, installing the second firmware may include storing the second firmware via one or more non-volatile memory media. For example, the first device may include the one or more non-volatile memory media. For instance, installing the second firmware may include storing the second firmware storing the second firmware to the one or more non-volatile memory media of the first device.

In one or more embodiments, the method of FIG. 6, and/or the methods of other figures, may be repeated. For example, the method of FIG. 6 may be repeated with a second device of the first information handling system. For instance, the method of FIG. 6 may be repeated with the second device as the first device. In one or more embodiments, the second device may be another instance of the first device. For example, the second device may provide the first device identification. In one or more embodiments, the second device may be different from the first device. For example, the second device may provide a second device identification, different from the first device identification. In one or more embodiments, terms such as “first”, “second”, “third”, etc. may be utilized as enumerations. In one example, “first”, “second”, “third”, etc. may refer a single element. In a second example, “first”, “second”, “third”, etc. may refer instances of same elements. In another example, “first”, “second”, “third”, etc. may refer to different elements.

In one or more embodiments, one or more of the method and/or process elements and/or one or more portions of a method and/or processor elements may be performed in varying orders, may be repeated, or may be omitted. Furthermore, additional, supplementary, and/or duplicated method and/or process elements may be implemented, instantiated, and/or performed as desired, according to one or more embodiments. Moreover, one or more of system elements may be omitted and/or additional system elements may be added as desired, according to one or more embodiments.

In one or more embodiments, a memory medium may be and/or may include an article of manufacture. For example, the article of manufacture may include and/or may be a software product and/or a program product. For instance, the memory medium may be coded and/or encoded with processor-executable instructions in accordance with one or more flowcharts, systems, methods, and/or processes described herein to produce the article of manufacture.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

1. An information handling system, comprising:
a processor;
a first device, communicatively coupled to the processor; and
a memory medium, communicatively coupled to the processor, that includes first instructions executable by the processor of the information handling system to cause the information handling system to:
receive a first device identification from the first device;
determine an identification associated with the information handling system;
determine a first identifier based at least on the identification associated with the information handling system and the first device identification;
provide, via a network, the first identifier and a first version identification of a first firmware associated with the first device to a second information handling system; and
receive, via the network, a second firmware that is different from the first firmware, that was selected for the information handling system based at least on the first identifier and the first version identification of the first firmware, and that includes second instructions, which are executable by a processor of the first device to implement one or more functionalities of the first device.

2. The information handling system of claim 1, wherein the identification associated with the information handling system includes manufacturer information.

3. The information handling system of claim 1, wherein the memory medium further includes instructions executable by the processor of the information handling system to cause the information handling system to further install the second firmware to the first device.

4. The information handling system of claim 1, wherein the identifier based at least on the identification associated with the information handling system and the first device identification includes at least one of a globally unique identifier (GUID) and an universally unique identifier (UUID).

5. The information handling system of claim 1, further comprising:
a second device, communicatively coupled to the processor of the information handling system and different from the first device;
wherein the memory medium further includes instructions executable by the processor of the information handling system to cause the information handling system to further receive the first device identification from the second device.

6. The information handling system of claim 1, further comprising:
a second device, communicatively coupled to the processor of the information handling system and different from the first device;
wherein the memory medium further includes instructions executable by the processor of the information handling system to cause the information handling system to further:
receive a second device identification, different from the first device identification, from the second device;
determine a second identifier based at least on the identification associated with the information handling system and the second device identification, wherein the second identifier is different from the first identifier;
provide the second identifier and a second version identification of a third firmware associated with the second device to the second information handling system via the network; and
receive, via the network, a fourth firmware that is different from the third firmware, that was selected for the information handling system based at least on the second identifier and the second version identification of the third firmware, and that includes third instructions, which are executable by a processor of the second device to implement one or more functionalities of the second device.

7. The information handling system of claim 1, wherein the first device identification is associated with at least one of a manufacturer of the first device, a model of the first device, a type of the first device, subsystem information of the first device, revision information of the first device, and subsystem manufacturer information of the first device.

8. A method, comprising:
receiving a first device identification from a first device of a first information handling system;
determining an identification associated with the first information handling system;
determining a first identifier based at least on the identification associated with the first information handling system and the first device identification;
providing, via a network, the first identifier and a first version identification of a first firmware associated with the first device of the first information handling system to a second information handling system, different from the first information handling system; and
receiving, via the network, a second firmware that is different from the first firmware, that was selected for the first information handling system based at least on the first identifier and the first version identification of the first firmware, and that includes instructions, which are executable by a processor of the first device to implement one or more functionalities of the first device.

9. The method of claim 8, wherein the identification associated with the first information handling system includes manufacturer information.

10. The method of claim 8, further comprising:
installing the second firmware to the first device.

11. The method of claim 8, wherein the identifier based at least on the identification associated with the first information handling system and the first device identification includes at least one of a globally unique identifier (GUID) and an universally unique identifier (UUID).

12. The method of claim 8, further comprising:
receiving the first device identification from a second device, different from the first device, of the first information handling system.

13. The method of claim 8, further comprising:
receiving a second device identification, different from the first device identification, from a second device, different from the first device, of the first information handling system;
determining a second identifier based at least on the identification associated with the first information handling system and the second device identification, wherein the second identifier is different from the first identifier;
providing the second identifier and a second version identification of a third firmware associated with the second device of the first information handling system to the second information handling system via the network; and
receiving, via the network, a fourth firmware that is different from the third firmware, that was selected for the first information handling system based at least on the second identifier and the second version identification of the third firmware, and that includes instructions, which are executable by a processor of the second device to implement one or more functionalities of the second device.

14. The method of claim 8, wherein the first device identification is associated with at least one of a manufacturer of the first device, a model of the first device, a type of the first device, subsystem information of the first device, revision information of the first device, and subsystem manufacturer information of the first device.

15. A computer-readable non-transitory memory medium that includes first instructions that, when executed by a processor of an information handling system, cause the information handling system to:
receive a first device identification from the first device;
determine an identification associated with the information handling system;
determine a first identifier based at least on the identification associated with the information handling system and the first device identification;
provide, via a network, the first identifier and a first version identification of a first firmware associated with the first device to a second information handling system; and
receive, via the network, a second firmware that is different from the first firmware, that was selected for the information handling system based at least on the first identifier and the first version identification of the first firmware, and that includes second instructions, which are executable by a processor of the first device to implement one or more functionalities of the first device.

16. The computer-readable non-transitory memory medium of claim 15, wherein the identification associated with the information handling system includes manufacturer information.

17. The computer-readable non-transitory memory medium of claim 15, wherein the computer-readable non-transitory memory medium further includes instructions executable by the processor of the information handling system that, when executed by the processor of the information handling system, cause the information handling system to further install the second firmware to the first device.

18. The computer-readable non-transitory memory medium of claim 15, wherein the identifier based at least on the identification associated with the information handling system and the first device identification includes at least one of a globally unique identifier (GUID) and an universally unique identifier (UUID).

19. The computer-readable non-transitory memory medium of claim 15, wherein the computer-readable non-transitory memory medium further includes instructions executable by the processor of the information handling system that, when executed by the processor of the information handling system, cause the information handling system to further receive the first device identification from a second device, different from the first device, of the information handling system.

20. The computer-readable non-transitory memory medium of claim 15, wherein the first device identification is associated with at least one of a manufacturer of the first device, a model of the first device, a type of the first device, subsystem information of the first device, revision information of the first device, and subsystem manufacturer information of the first device.
